(19) United States
(12) Patent Application Publication
(10) Pub. No.: US 2012/0278203 A1
(43) Pub. Date: Nov. 1, 2012

(54) Buy First

(76) Inventor: Jacque Ojadidi, Henderson, NV (US)

(21) Appl. No.: 13/095,030

(22) Filed: Apr. 27, 2011

(51) Int. Cl. G06Q 30/00

(52) U.S. Cl. 705/27.1

(57) ABSTRACT

BUYFIRST is a clickable button that appears on the website and or websites within the network for shopping. The BUYFIRST button was designed in red and blue. The BUYFIRST button has been designed and programmed into the shopping system platform to enable a purchaser of products and services to use as a check out button to a computer enabled shopping platform network. Buyers are using their desired methods of payments or choices of payments our network provides to use the BUYFIRST button to make a final purchase of goods.

### BACKGROUND OF INVENTION

The Buy First button used on the website and the websites networks allows consumers an aesthetic appearance and the ease and clear functionality to check out on the website quickly and easily with easily proceeding from the product page, to the check out page where the shopping cart appears, where they choose their payment preferences to purchase goods or services online. Our Buy First button was developed to give consumers a clear concise visual experience in the purchasing decision.

### SUMMARY OF INVENTION

The Buy First button is a method of purchasing products and services on a computer enabled, combined shopping network by clicking on an integrated button on the website called “Buy First” to make a purchases for products and services on a computer enabled network.

### DETAILED DESCRIPTION OF INVENTION

The Buy First method offers the combined use of comparisment shopping and a “Buy First” product purchase features for shopping portal on a computer enabled device using the Buy First clickable button. The Buy First button is used in combination for the use of classifieds, social networks, blogs, auctions, coupon, rebate websites, review websites and additional platforms were people can purchase digital and tangible items on mobile devices, ipdad, net books, and any wireless or wired devices that they offer internet access.

Method of a selling feature with a Buy First clickable button feature on a website for listing and posting items for sale and offering the consumer the feature to be able to click a button on the shopping website and “Buy First” and the seller to use a “Buy First” only feature.

The “Buy First” feature and clickable button allows the seller to use a “Buy First” only choice as an instant purchase combined even with a product or service for sale, which may also offer the item in an auction style. This is used in combination with option for the buyer to make a “Buy First” purchase when the seller or website is also offering an auction style feature and allows the item to be purchased instantly instead of waiting for that specific time frame to end. Users can log on the network shopping network with one login to perform all tasks at the same time without going to another website in the CWEB® network and use the “ Buy First” feature to purchase their goods and services without an auction or bidding feature across all platforms within our network. “Buy First” allows users to purchase the item before anyone else has purchased the item. The seller can choose from a drop down menu when listing an item on the website to choose the “Buy First” option as a method of choice on the computer enabled network.

### DESCRIPTION OF DRAWINGS

Ref 1.A The line pointing to the words Buy First that are written on a clickable button where the buyer will click and proceed to check out on the website to make a purchase. Buyers will move their computer mouse or finger on a mobile device to click on the Buy First button to enable them to proceed to the shopping cart.

Ref 2.A

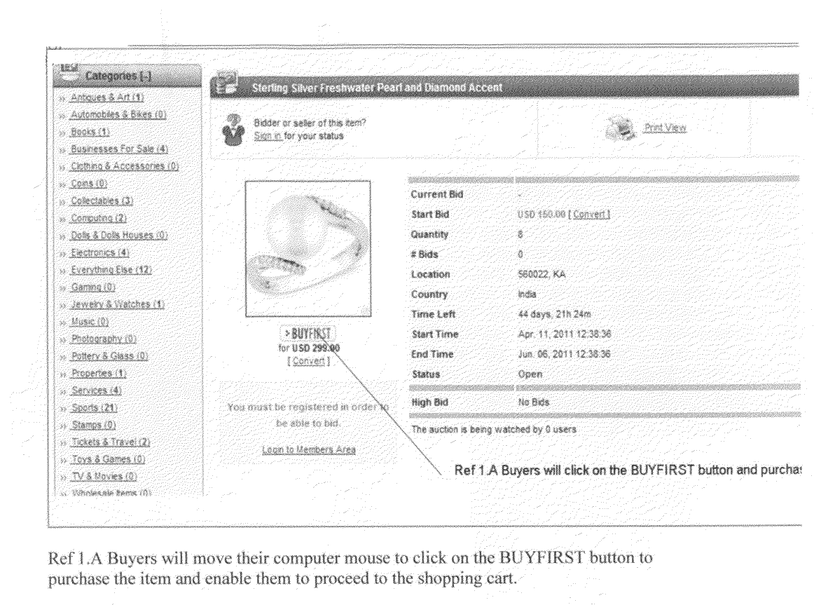

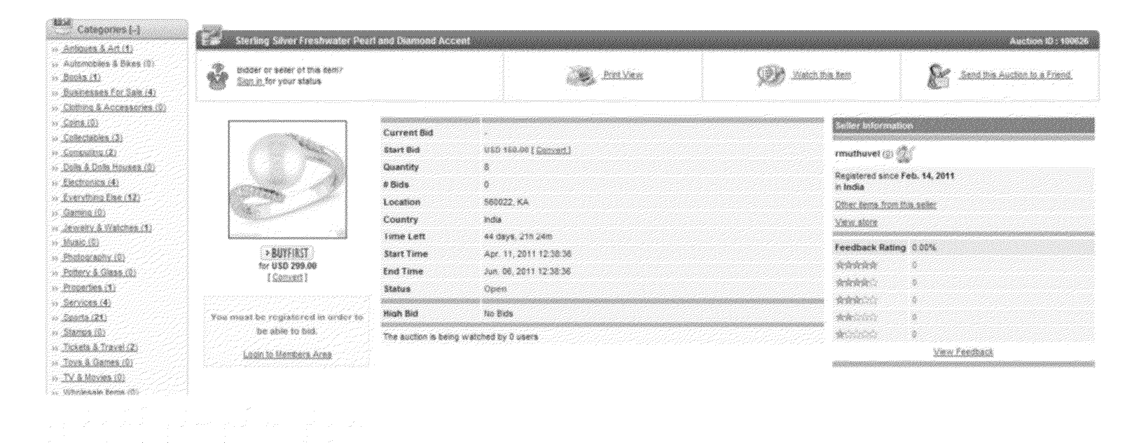

Drawing FIG. 2.A

Referring to FIG. 2.A

The actual button that is located near the products on the website pages

1. The BUYFIRST clickable button is programmed into the website shopping platform. The buyer is able to utilize the purchasing of goods in electronic ecommerce platforms for a computer enabled network platforms to purchase goods on mobile devices, net books, wireless devices and computers that enable connections to the internet.

2. I claim The BUYFIRST clickable button is a choice over an auction style waiting period that may also be offered in the platform when an listing is made on the network as an auction and the buyer wants a BUYFIRST option without waiting for a specific auction to end within a specific amount of time.

3. I claim The BUYFIRST button is offered on all items that are listed even if no auction style platform is presented on the network.
